(19) United States
(12) Patent Application Publication
(10) Pub. No.: US 2026/0335816 A1
(43) Pub. Date: Oct. 29, 2026

(54) MEANS FOR QUANTITATIVELY REMOVING WATER FROM A GAS STREAM, APPARATUS THERE-FOR AND USE THEREOF

(71) Applicant: ELEMENTAR ANALYSENSYSTEME GMBH, Langenselbold (DE)

(72) Inventors: Jan HARTWIG, Alzenau (DE); Sabine KRAUS, Alzenau (DE)

(21) Appl. No.: 19/113,579

(22) PCT Filed: Sep. 29, 2023
(86) PCT No.: PCT/EP2023/077119

§ 371 Date: Mar. 20, 2025

(30) Foreign Application Priority Data
Oct. 20, 2022 (DE) 20 2022 105 926.8

(51) Int. Cl. B01D 53/26; B01D 53/14; B01J 20/04; B01J 20/16; B01J 20/18; B01J 20/28; G01N 31/22

(52) U.S. Cl. CPC B01D 53/263; B01D 53/1412; B01J 20/046; B01J 20/165; B01J 20/18; B01J 20/2808; G01N 31/223; B01D 2252/10; B01D 2252/504; B01D 2252/60; B01D 2257/80; B01J 2220/46; B01J 2220/49

(57) ABSTRACT

The invention relates to a material for the quantitative removal of water from a gas stream, wherein the material comprises a mixture of molecular sieve and calcium chloride provided with an indicator. The invention also relates to the use of this material in devices for chemical analysis, in which the quantitative removal of water is particularly important.

The invention relates to a mixture for the quantitative removal of water from a gas stream.

The purity of gases plays a major role in a large number of processes. An essential aspect of this is the removal of water. Particularly in the analysis of gases, it is necessary to quantitatively remove water contained in the gas stream to be analysed, whereby the term “quantitatively” in the sense of the invention is to be understood as meaning that the water content is reduced to a value of less than 100 ppm.

The need for such water removal affects all existing analysis systems and modes for measuring nitrogen, carbon and oxygen, but also, for example, TOC analysis or IRMS analysis. Usually, in such a drying process, the gas flow to be analyzed is passed through a tube that is partially filled with the drying agent, so that the gas must inevitably pass through the drying agent and water is removed as a result.

Until now, phosphorus pentoxide desiccants on inert carrier material, known primarily under the name Sicapent®, or magnesium perchlorate have been used in gas analysis, as these desiccants are suitable for actually removing water quantitatively. What these materials have in common, however, is that they are not only highly hygroscopic, but also tend to form acids and explosives as strong oxidising agents in combination with other substances. The use of these materials therefore requires a high level of occupational safety and appropriate training for the personnel working with them. A further disadvantage of these materials is that their production is very costly, energy-intensive and involves large quantities of waste.

Other common drying agents are either not suitable for actually removing water quantitatively or they are not inert to all gas streams. For example, side reactions often occur with the known drying agent silica gel, so that the analysis result is falsified by the pre-drying, since components in the drying agent are either bound or changed.

The invention is therefore based on the task of providing a simple and safe material for the quantitative removal of water, which is also particularly suitable for drying a gas stream prior to a downstream gas analysis. For this purpose, the drying agent must not react or interact too strongly with the measurement gases, as this would lead to a change in the measurement signal.

This problem is solved with a material according to claim 1.

Such a material according to the invention comprises a mixture of molecular sieve and calcium chloride provided with an indicator. The molecular sieve is able to remove the contained water quantitatively. It thus ensures the necessary dryness of the gas stream (dry efficiency), especially for elemental analysis.

The term “molecular sieve” or molecular sieve in the sense of the present invention is to be understood as a functional designation in particular for natural and synthetic zeolites. However, the terminology also includes other substances which, like cellulites, have the inherent property of having a high adsorption capacity for gases, vapours, and dissolved substances with certain molecular sizes. Such molecular sieves, in particular natural and synthetic zeolites, have a comparably large inner surface area, preferably in the range of 500 to 760 m²/g. They also have a very high porosity. They also have a very large pore diameter, which is of the same order of magnitude as the size of the molecules to be adsorbed. The pore diameter given in Ångström is generally used to classify molecular sieves.

The advantage of using a molecular sieve is that it does not dissolve when water is absorbed and therefore retains its solid form and structure even when a dry tube is used. When used in elemental analysis, this prevents clogging and the entrainment of liquid fractions with the gas flow, which would at least lead to measurements being cancelled or incorrect measurements. A permanent entrainment of material would also result in a more frequent change of the drying agent and, in the worst case, damage to the device.

Although the use of a molecular sieve alone would ensure suitable and sufficient drying, so-called molecular sieves are designed in such a way that it is not possible to apply an indicator and thus recognise when the drying capacity of the molecular sieve is exhausted due to their dark coloring and/or their ability to retain water in the sample. The user is therefore left in the dark as to whether the drying agent can still be used or whether the water can no longer be completely removed and the residual water contained in the gas flow has long since falsified the measurement result.

Calcium chloride is therefore added to the mixture according to the invention as a second drying agent. The use of pure calcium chloride as the sole drying agent would not be sufficient to ensure the quantitative removal of water, which is particularly important for gas analysis, but calcium chloride is well suited to making a clear color change visible when the calcium chloride contains an indicator due to its colorless, non-transparent crystals. Due to the ability of calcium chloride to absorb large quantities of water and then dissolve itself in the crystal water, the color change is particularly visible when exposed to water. The indicator thus allows the optical traceability of water absorption.

The combination of molecular sieve and calcium chloride also has the advantage that even after completion of the aforementioned dissolution process of calcium chloride, a complete liquid phase cannot form over the entire cross-section of a drying tube or other container holding the agent according to the invention, as the solid structure of the molecular sieve is retained.

Further advantages of using calcium chloride are that, like the molecular sieve, calcium chloride is inert to practically all gas flows to be measured. This applies not only to the typically used carrier gases helium and argon, but also to carbon dioxide. In addition, however, it also has the advantage that calcium chloride acts as a drying agent, as already mentioned, and therefore the introduction of an indicator on a carrier material does not lead to a dilution of the drying material itself. This in turn has the advantage that the total quantity of mixtures can remain the same in comparison to material with an indicator and material without an indicator, which plays a role in pressure loss, dead volume or service life, among other things.

It has been found that the material according to the invention has a significantly higher water absorption capacity per volume than the previously known drying materials. In comparison, the water absorption of Sicapent® is lower by a factor of about 2 due to the significantly lower bulk density over a wide mixing range.

To summarise, the advantage of the new invention is to provide a way of using a new desiccant for C, N and O determinations with the aid of simple chemicals available in large volumes, which at the same time indicates the depletion of the desiccant. The hazard potential of the material has also been significantly reduced, making it safer and easier to process, supply and use. Thanks to the increased absorption capacity per volume, the utilization time could be extended by a factor of 2 while maintaining the same container volume.

Molecular sieves between 3 and 4 Ångstrom can be used for the mixture, in particular various 3 Å molecular sieves, whereby this means that preferably at least 70 wt. %, preferably at least 90 wt. % over the pore diameter are used. 3 Å molecular sieves are particularly favored because they absorb and release less gas during the measurements compared to larger-pored molecular sieves, which prevents the measurement results from being falsified.

Furthermore, it has been found to be favorable if the proportion of the molecular sieve in the total mass of the mixture is between 60 and 95 wt.-%, preferably between 80 and 93 wt.-% by weight and particularly preferably between 85 and 90 wt.-%. The remaining difference to the total amount is then accounted for by the calcium chloride containing the indicator in any form, so that its amount is between 5 and 40 wt.-% relative to the total amount of the drying material, preferably 7 to 20 wt.-% and particularly preferably between 10 and 15 wt.-%. On the one hand, this ensures highly efficient drying and, at the same time, a clearly visible color change when the drying capacity is exhausted.

The indicators used, which show a color change depending on the moisture in the surrounding medium, can be both inorganic and organic.

Inorganic indicators are often less expensive on the market. Among the inorganic indicators, the use of copper(II) sulphate (Cu(II)SO₄) is particularly favored. Copper(ii) chloride can also be used. The advantage here is its harmlessness. When used together with calcium chloride, the color changes from colorless to blue as soon as the primary drying agent, the molecular sieve, is no longer able to remove the water quantitatively.

Organic substances often show very clearly recognisable color differences. Phenolphthalein is particularly suitable as an organic substance. Phenolphthalein has the particular advantage that when the capacity of the molecular sieve, which is completely filled with water within its pores, is exhausted, it shows a color change to white, which is clearly visible against the dark brown color of the molecular sieve. Over the course of the measurements, this “front” shifts further and further in the direction of flow towards the gas outlet. As soon as this color change reaches the gas outlet, there is no longer a sufficient quantity of desiccant to completely remove the water. If, on the other hand, the mixture according to the invention is stored for a longer period of time in such a way that it is exposed to air humidity so that the water is not carried through a gas flow, this changes the reactions that lead to the color change of the indicator. The indicator (In) then does not have the structure H₂In, which leads to a white coloring, but is present as In²⁻ and thus turns pink-violet. This pink color clearly shows that moisture has slowly diffused in. This also makes it easier to detect the cause of the depletion of a column's absorption capacity, in particular storage errors.

Furthermore, the calcium chloride (CaCl₂)) containing the indicator can be coated with the indicator so that it lies on the surface of the calcium chloride acting as a carrier material. Alternatively, it is also possible to mix the indicator with the calcium chloride and form it into granules or beads, for example by pressing. The latter is less complex to produce than the aforementioned coating, but the color change is sometimes more visible with a coating due to the higher local concentration on the surface, depending on the type of indicator used.

In summary, the desiccant is characterized by a particularly long service life, easy handling and an optical indicator that ensures optical traceability of water absorption. In addition, unlike the substances used to date, the material is not a hazardous substance.

The invention also includes a device for drying gases in the sense of a quantitative removal of water, in particular in preparation of a gas stream for subsequent analysis. Such a device has a gas-tight housing and a gas inlet and a gas outlet.

The volume defined by this housing is at least partially filled with the material according to the invention according to at least one of claims 1 to 6. The material according to the invention can be used directly in any gas analysis, in particular in any elemental analysis, without modifying the system. A filled tubular reactor is a particularly simple embodiment of such a device.

In principle, the device can be made of any material that is inert and gas-tight with respect to the gas flow to be analyzed. It must also be at least partially transparent. Metals, glass and plastic are conceivable base materials. If metals and non-transparent plastics are used, a viewing window made of glass or a corresponding transparent plastic must be provided so that the indicator turns over and the exhaustion of the service life of the desiccant is visible. In particular, glass and sometimes plastic as the base material has the advantage that such viewing windows are not necessary. When moving a color change over the length of the container, especially the tube, this has the advantage that the effect is clearly visible. Glass is particularly favored as a housing material due to its inert properties.

In principle, it is also conceivable to fill the device according to the invention sequentially with a series of materials, for example to first provide the flow direction with a carbon dioxide-absorbing material and then the drying agent according to the invention from the mixture.

Finally, the invention is also directed to the use of the material according to the invention according to any one of claims 1 to 6 and/or an apparatus according to the invention according to claim 7 or 8 for the quantitative removal of water in a gas analysis system. In particular, this relates to gas analysis systems for the determination of nitrogen, carbon, hydrogen and oxygen (CHNO). The material according to the invention is particularly suitable for completely removing water from the gas flow head without changing the flow behaviour and at the same time reliably indicates the exhaustion of its drying capacity due to the indicator it contains. The use of the material is not limited to specific devices but can be used in all applications that identify non-acidic, dry gas flows. Other conceivable areas of analysis include TOC analysis and IRMS analysis. A dry gas flow is also the basic prerequisite for precise, linear and repeatable results over the entire measuring range for a thermal conductivity detector WLD.

Further embodiments of the invention are shown in the examples and the figures and their associated description. Each feature is to be regarded as disclosed individually or in any combination. Some of the figures are slightly simplified and schematic.

It shows:

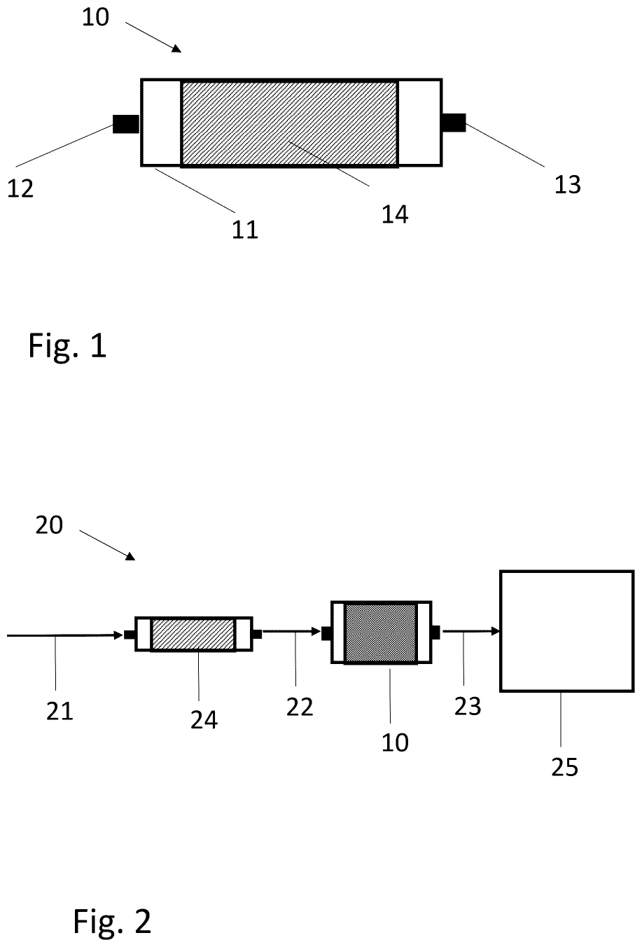

FIG. 1: a schematic embodiment of a device according to the invention and

FIG. 2: a schematic diagram of the use of a device according to the invention in a gas analysis system

FIG. 1 shows the device 10 according to the invention, which is designed as a preferably cylindrical housing 11 with a gas inlet 12 and a gas outlet 13. Inside there is a filling 14 with the material according to the invention, which is inserted in such a way that the gas flow flowing in through the gas inlet 12 must pass through the material in any case before it can escape via the gas outlet 13.

FIG. 2 shows a very simplified gas analysis system 20, preferably an elemental analysis system, in which the material according to the invention is used for the quantitative removal of water. Via lines 21, 22 and 23, the gas flow is first passed through a device for removing carbon dioxide 24 and then through a device 10 according to the invention before it is analyzed in the detector 25.

As an alternative to the graphical representation, the functions of the devices 24 and 10, i.e. carbon dioxide removal and drying, can also be arranged in a device in such a way that this device has two segments into which a corresponding material is filled. In particular, this may be a tube which is filled with the mixture according to the invention in a first part and with a drying agent in a second part downstream with respect to the flowing gas stream.

In addition, an undisclosed pre-drying process can be provided before the removal of carbon dioxide.

### EXAMPLE 1

The following example shows how many measurements can be carried out with which type of absorbent for the quantitative removal of water before the indicator contained in each case indicates a complete loading with water.

The values given are average values over 3 service life tests in each case.

| | Number of measurements |
|---|---|
| Drying material | (service life) |
| Sicapent ® | 244 |
| Mixture according to the invention | 578 |

The following example shows that due to the very good drying properties of the molecular sieve, its drying capacity is increased by a factor of 2 in an identical filling volume, so that conversely the service life of a column is significantly increased.

### EXAMPLE 2

To determine the drying effectiveness of the material according to the invention, an analyzer without a desiccant and then different desiccants were used. For better comparability, an automatic liquid sample application was used. The drying effectiveness (amount of water removed in relation to the total amount of water present) can be determined from the ratio of the values when using the respective desiccant to the analysis without desiccant. The mean value from 10 analyses was used for the calculation.

| Drying material | Drying effect |
|---|---|
| Sicapent ® | 99.83% |
| EAS WETSORBER ® | 99.73% |
| (according to the invention) | |
| Magnesiumperchlorat | 99.59% |
| Aquatak ® | 54.72% |
| Drierite ® | consumed after 4 samples - no result |

### LIST OF REFERENCES

10 device
11 housing
12 gas inlet
13 gas outlet
14 filling with material according to the invention
20 gas analysis system
21-23 line
24 device
25 detector

1. Material for the quantitative removal of water from a gas stream, characterized in that the material is a mixture of molecular sieve and calcium chloride provided with an indicator.

2. Material for the quantitative removal of water from a gas stream according to claim 1, characterized in that at least 70 wt.-% of the molecular sieve has a pore size of 3 Å or 4 Å, preferably 3 Å.

3. Material for the quantitative removal of water from a gas stream according to claim 1, characterized in that the proportion of the molecular sieve in the total mass of the mixture is between 60 and 95 wt.-% preferably between 80 and 93 wt.-% and particularly preferably between 85 and 90 wt.-%.

4. Material for the quantitative removal of water from a gas stream according to claim 1, characterized in that the indicator is an inorganic compound, in particular copper (II) sulphate.

5. Material for the quantitative removal of water from a gas stream according to claim 1, characterized in that the indicator is an organic compound, in particular phenolphthalein.

6. Material for the quantitative removal of water from a gas stream according to claim 1, characterized in that the calcium chloride is at least partially coated with the indicator or calcium chloride and indicator are present together in granules.

7. Device (10) for absorbing water with a gas-tight housing (11) which has a gas inlet (12) and a gas outlet (13) and whose volume is at least partially filled with a material according to claim 1.

8. Device (10) according to claim 7, characterized in that the housing is at least partially transparent.

9. Use of a material according to claim 1 for the quantitative removal of water in a gas analysis system (20) for the determination of nitrogen, carbon, hydrogen and/or oxygen.

10. Use of a material according to one of claim 1 for the quantitative removal of water in a TOC analysis or an IRMS analysis.

11. Use of a device according to claim 7 for the quantitative removal of water in a gas analysis system (20) for the determination of nitrogen, carbon, hydrogen and/or oxygen.

12. Use of a device according to claim 7 for the quantitative removal of water in a TOC analysis or an IRMS analysis.
